(19) United States
(12) Patent Application Publication
(10) Pub. No.: US 2006/0029199 A1
(43) Pub. Date: Feb. 9, 2006

(54) Messaging system and method

(75) Inventors: Michael Osterer, Elmsford, NY (US); Debra Scotto, Brooklyn, NY (US)

Correspondence Address: DARBY & DARBY P.C., P. O. BOX 5257, NEW YORK, NY, 10150-5257, US

(73) Assignee: U-E Systems, Inc., Elmsford, NY (US)

(21) Appl. No.: 11/202,951

(22) Filed: Aug. 11, 2005

Related U.S. Application Data
(60) Provisional application No. 60/600,770, filed on Aug. 11, 2004.

(51) Int. Cl. H04M 1/64

(52) U.S. Cl. 379/88.22

(57) ABSTRACT

A system provides messages from deceased relatives and friends, which messages are readily accessible. Before death a person records various messages for loved ones. The system stores these messages at a location and associates PIN numbers with each individual for whom there is a message. Either the intended recipient is given information about the message or leaving of a message by a symbol located in a conspicuous place, e.g., on the headstone of the deceased. The person then calls a 900 number or logs onto a specific website. In response to the correct answers to certain questions, the intended recipient is given their PIN. Using the PIN, the person can contact the system and received the recorded message at any time, e.g., by cell phone at the grave site. Alternatively, the grave site itself can be wired to provide the message, e.g., from a tape recorder over headphones or at special kiosks at the cemetery.

### BACKGROUND OF THE INVENTION

It is a common desire to hear the voice of a loved one after death. The reminder of his or her feelings and wisdom after death can truly provide consolation. It is also often difficult for someone to divulge certain types of information before death, whether it is concerns behavior and its consequences or certain types of financial transactions. This invention is intended to satisfy these common needs. While in the past, letters and tapes would be used to meet these needs, there remained problems of confidentiality, timing and access. Letters and tapes can be destroyed. They can fall into the wrong hands. They can be forwarded before or after the intended time of delivery and at a time when recipient is not ready to deal with them. This invention moves beyond letters and tapes and solves the problems just mentioned. In particular, this invention relates to the timed delivery of messages, and more particularly, to estate planning and the reduction of stress from bereavement due to post mortem messages of consolation from departed love ones and friends.

When a person contemplates their own mortality, it is common for them to plan for the care of the people left behind. This care is typically both financial and emotional. The financial component is taken care of by insurance policies, wills and trusts. To ease the emotional impact of their passing, people frequently leave letters, audio tapes and even video tapes of final messages which are to be played after their death. These messages usually express concern for the living and provide some message which the sender believes will ease their feeling of loss.

One problem with messages and tapes is access. Typically they are single items provided to estate lawyers for distribution to the relatives and friends of the decedent. They can become lost or damaged. Also, they may not be available when it is desired to read, listen to or view them. For example, during a trip to a grave site there may be a desire to read the letter. However, unless this was realized before making the trip, it is likely not to be in the possession of the relative or friend making the stop at the grave. If it is an audio or video tape, even if it is present, it is not likely the equipment to listen to it or view it would be available at the grave.

In an attempt to overcome the availability issues, it has been proposed in the past that pre-recorded messages be left at the grave site. However, these are single messages, which might not be appropriate to all visitors. Also, it may be difficult to hear such a message at the grave site and/or the playing of the message may be disturbing to people visiting nearby grave sites. Headphones may cure some of these problems, but have their own problems. They may become damaged by being out in the weather or vandals may steal them.

The problem of appropriate messages for particular individuals also remains largely unsolved. While a separate letter to each individual of concern to the deceased may be relatively easy to achieve, the production and distribution of numerous audio and/or video tapes could be problematic. Also, care must be taken in the playing of these tapes in those circumstances where the message is meant only for a particular individual.

In addition to messages timed for delivery after death, there can be a need for a message whose delivery is to occur at a particular time in the future. There may be periodic messages on special occasions, so that the sender can be sure not to forget. They may also be messages that are best delivered after the sender has left the area, perhaps because of a hostile reaction from the recipient.

### SUMMARY OF THE INVENTION

The present invention is directed to providing, through a service conducted using computerized equipment, individualized messages from departed relatives or friends to their loved ones which are accessible via modem electronic communications at any time. The messaging service provided by the system of the present invention can be responsible for receiving, storing, and distributing the messages, which may be accomplished through the use of a message center. A person could phone in to the message center, record their message, designate who should have access to the message, when they should have access to the message, and provide information or materials that could be used by the message center to ensure that the message was distributed to the proper people.

The existence of particular messages can be made known to the loved ones through messages in wills, personal letters, by logos or inscriptions at the grave site, e.g., on headstones, or by notification from the messaging service. The messages may be accessed from the service by cellular phone, over the Internet, at kiosks provided at cemeteries, at facilities located in the office of the cemetery or at safety deposit box areas in banks. The message may also be accessed from the service using audio or video display equipment located at the gravesite.

Even if the sender is alive, the present method and apparatus may prove to be a convenient way to achieve timed delivery of a message automatically or at least without the sender being in the area or having to take any action. This is a particularly good way to assure that a special occasion is not forgotten.

Also, it can be used where face-to-face communication may not be possible, e.g. in an uncomfortable divorce situation where the estranged parent wants to leave a message for their emancipated child whether or not the messenger is still alive or post mortem.

This system could also be used to leave a message for a parent or friend from a runaway to let the parent or friend know that the child is alive and well thereby alleviating some concerns.

The service may provide individuals with passwords or personal identification numbers (“PINs”) which cause or authorize individualized messages to be played. The messaging service can also provide access to messages based on biometric identification information, which can include fingerprint and/or DNA information. Once a recognized password or biometric information is received by the messaging service, the messaging service can provide the appropriate message. In this way, each message can be tailored for particular individuals. Further, the messaging service can protect the messages by using an encryption method, such as double blind encryption, to ensure that access to messages is limited to intended recipients and to maintain privacy.

### BRIEF DESCRIPTION OF THE DRAWINGS

The foregoing and other features of the present invention will be more readily apparent from the following detailed description and drawings of an illustrative embodiment of the invention in which:

FIG. 1 is a diagram illustrating transactions with a messaging system to provide a service in accordance with the present invention.

FIG. 2 is a block diagram of the message center in accordance with an embodiment of the present invention.

FIG. 3 is a view of a message retrieval device in accordance with one embodiment of the present invention.

FIG. 4 is an illustration of a person receiving a message from the messaging service at a gravesite using a device in accordance with one embodiment of the present invention.

### DESCRIPTION OF ILLUSTRATIVE EXEMPLARY EMBODIMENTS

When preparing a will, doing estate planning or any other activity connected with death, e.g., during the purchase of a cemetery lot, the existence of a messaging system providing a service according to the present invention would be presented as a viable option to the person contemplating their mortality. However, the use or offering of the service does not necessarily have to be in connection with the preparation of a will, or to even be connected with death. It can be in place of a will or in addition to it, if permitted by the law of the state involved. The service may be offered to various persons, such as a parent with terminal illness, someone leaving a message for a young child to be retrieved when they become of age, someone going off to war, someone leaving contact information for an individual that has been separated or ran away from loved ones, or someone who wishes to confess to a crime. Further, a person could also become aware of the service though advertising. In any case, the person would be offered the opportunity to leave personalized messages for loved ones which would be readily accessible by them.

The benefits of the present invention can also be realized in any setting in which the delayed timing of the delivery of the message, without the sender's intervention, would be beneficial.

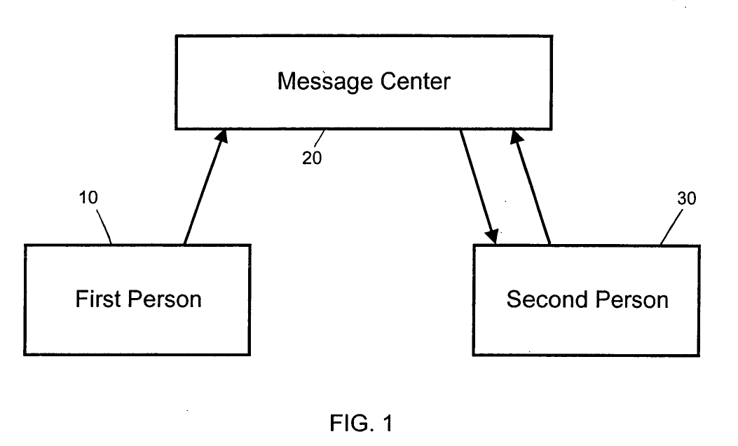

FIG. 1 is a diagram illustrating one possible embodiment of the system according to the present invention where a first person at a communications device 10 is contacting the messaging service 20 of the system in order to leave a message for a second person at a communications device 30. The second person is receiving the message from the message center 20.

The communications devices 10, 30 may be phones with land lines, cellular phone, PDA's or computer terminals. The connection from the communications devices may in part be over the Internet. The equipment at the message center 20 includes equipment that can send and receive calls from the communications devices.

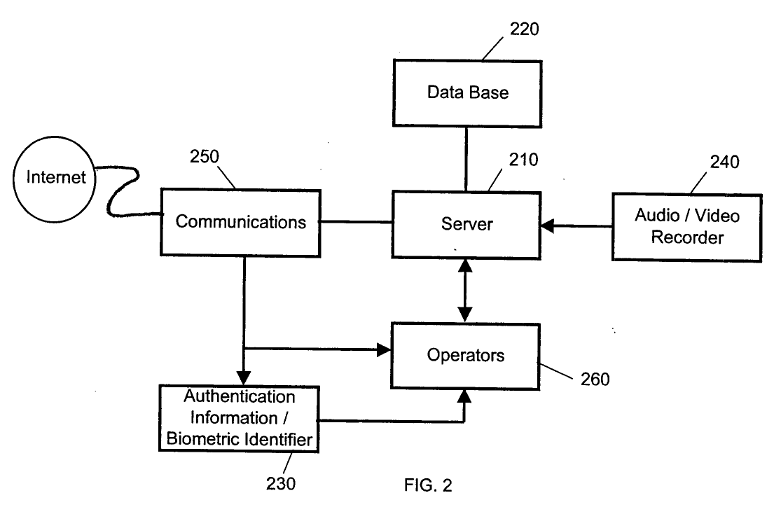

As can be seen from FIG. 2, which is a diagram of the message center 20, in addition to the communications equipment 250, it includes at least one computer, e.g., a server 210, and an electronic database 220 in which the messages are recorded and information about the transaction is maintained. The information would include who the message is from, who it is to be delivered to, when it is to be delivered, and the authentication information needed before the message is sent. The authentication information may include passwords, and/or biometric information. Devices 230 to receive and/or analyze the authentication information may also be provided in the system at the message center.

The message center may be staffed with operators 260. The operators would be responsible for receiving information from clients and entering that information into data base 220 via the server 210. The may also be responsible for receiving the authentication information 230.

The messages may be digitized and stored in the database 220. However, as an alternative, the system may have audio and video recording equipment 240, either analog or digital, that is maintained and controlled by the server at the message center.

In one example of use of the system, the first person would be a client of the service and the second person would be one of the client's loved ones. To use the messaging service the client would contact the message center, e.g., by calling the center or connecting to it over the Internet. The message center would be a centralized facility responsible for maintaining the functions of the service, such as managing customer accounts, receiving and storing messages, and distributing messages. Alternatively, the message center could be a decentralized system where each function is managed by separate facilities.

Once the client contacts the message center, the message center collects information from the client to setup an account. The message center also collects information from the client for identifying who should have access to the message. The message center could also collect a fee from the client for using the service. In addition to this initial setup fee, the client could pay the service a fee that would permit loved ones free access to the messages. In this way, the messages could be a gift from the client to the client's loved ones.

After the account is initiated, the message center receives and records a message from the client. If it is other than a text or voice message, e.g. a video message or photographs, the message could conveniently be sent to the message center via a computer connection over the Internet. Alternatively, a tape with audio or video images could be mailed to the message service. The messaging center could also permit the client to record and store additional messages and designate who should have access to each.

Messages are made available to the intended recipient by the messaging service at particular dates chosen by the client. Examples of such date specific messages are:
1) Time specific birthday, milestone and holiday greetings to children and significant others, whether the sender is alive or deceased;
2) Information relating to time dated distributions of trust income; and
3) General messages that could be retrieved at will by the family and significant others for comfort purposes.

After the message center has received the information and message from the client, the client's loved one would be notified of the existence of the message. The notification could be provided after the death of the client or at any desired time, before or after the death of the client. The client could provide the notification to the loved one through a message in a will, in personal letters, by logos or inscriptions at the grave site, e.g., on headstones. Also, if the client desires, the notification could be provided by the messaging service.

Once the loved one is aware of the message, the loved one can contact the message center. A phone number may be provided by the messaging service so the loved one can call into the message center. The message service may charge a fee to the loved one for retrieving the message, thus the loved one may be required to provide credit card information or the number may be a toll or “900” number. The loved one would give specific information relating to the account left by the deceased client and the message center would provide them with a PIN code or password along with a phone number that could be used to retrieve the message. For messages that are restricted to particular persons, the person attempting to retrieve the message may be required by the message center to provide identification information to ensure that the proper person gains access to the message. As an alternative, the notification message to the intended recipient may include a preassigned password or PIN.

Subsequently, the person could dial a 900 number and use the PIN to hear the message at any time or place. As a result of the use of the 900 number, the company administering the audio message retrieval service can collect on each call. In addition to a fee charged to the loved one for retrieving the message, or as an alternative, a registration fee can be charged to the client for setting up the account and leaving the message.

Instead of a phone number, a website could be provided to distribute the PIN numbers. In such a case, if desired, the web site could require credit card information to pay for retrieving the information. Also, the message for the recipient could be transmitted by the service over the Internet. Beyond retrieving the message using stationary internet connections, the message could be retrieved in a wide variety of circumstances given Internet connections over cell phones, by wireless Personal Digital Assistant's (“PDAs”) or other hand held computer devices, and by wireless connections to laptop computers. If retrieval is by way of the Internet, video as well as audio messages may be sent. Video messages may also be sent to cell phones equipped with video displays. In particular, specific video messages may be left by the sender and retrieved from the messaging service by the recipient by dialing a particular number and having the audio/video message played over their video-enabled cell phone.

An individual can always contact the messaging service to see if any messages have been left for him. If there are messages specifically related to dates, but no message is available at the present time, the messaging service can inform the individual of the date or dates when he can retrieve the message. However, if the individual who left the message is still alive, and so desires, the person trying to retrieve messages will not be notified of the existence of a message. There may also be general messages available to access at any time in addition to messages which are time sensitive or directed only to specific individuals. As a further alternative, the message center can send a notification of the existence of the message to the recipient, e.g., by a voice message or e-mail. In that way, if a special day is to be honored, e.g., a birthday, on the birthday the recipient will be contacted and informed that a message is waiting.

There can be an indicia or symbol on headstones and mausoleum crypts to indicate that the messaging services of the present invention are available from the deceased to their family and significant others. This can include information about where to call or how to contact the messaging service. Further, the cemetery management can be enlisted to act as an information center to direct people to the messaging service's contact information.

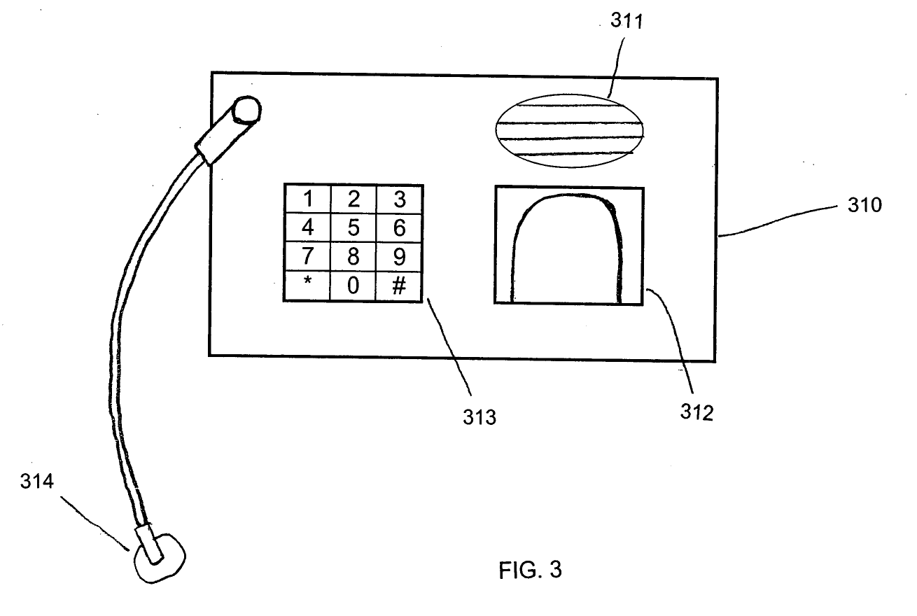

FIG. 3 is a illustration of a device 310 that could be used to access messages from the messaging service at the gravesite of the person who left the message. The device 310 includes a keypad 313, a fingerprint scanner 312, a speaker 311, and an earphone 314. A person visiting the gravesite of a loved one could use device 310 to access messages from the messaging service. The person would use the keypad 313 to enter in a PIN code that was previously received from the messaging service or the loved one. Once the correct PIN code was entered, the message could be retrieved. Alternatively, if the messaging service has the fingerprint information of the person wishing to retrieve the message, the person could place their finger on the fingerprint scanner 312. After the fingerprint was verified, the message could be retrieved. As another alternative, the fingerprint scanner 312 could be substituted with, or accompanied by, any biometric information collection device, such as a DNA collector or retina scanner. Moreover, device 310 could include either keypad 313 or scanner 312, or both together.

After the person has been approved to retrieve the message from the service, the message can be listened to by using the earphone 314. If the person chooses, the message could also be listened to using speaker 311. Device 310 could include either earphone 314 or speaker 311, or both together.

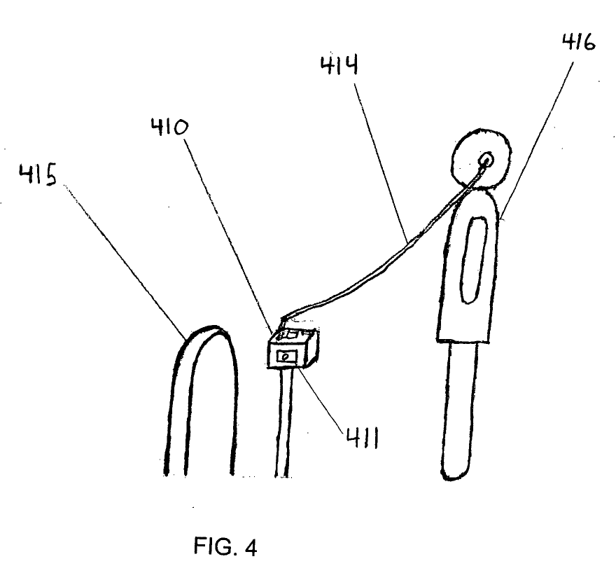

FIG. 4 shows a person 416 using device 410 to listen to a message at a gravesite 415 using earphone 414. The person 416 is could be a loved one of the client who left a message with the messaging service. The loved one 416 is at the gravesite of the client 415, listening to a message using earphone 414 that is being retrieved from the messaging service using device 410. To avoid vandalism, the earphone 414 could be located in a locked portion 411 of the device which is accessed only after the PIN has been authenticated.

The message could be remotely transmitted by the messaging service to the device 410, e.g., by using radio waves. The device 410 could also have means for storing the recorded messages within the device. When a person attempts to access a message using device 410, the message may either be transmitted to the device and played, or the message could be played from an internal storage device, such as a hard drive. Additionally, the device 410 may be purchased from and maintained by the service.

In another embodiment of the, device 310 of FIG. 3, the keypad 313 could be used to contact the message center, e.g., by calling the message center. If a person is visiting the gravesite and wants to retrieve messages but has forgotten or not received their PIN code from the messaging service, the person could dial a phone number for the messaging service using the keypad 313. The earphone 314 could be used to listen to the messaging service and speaker 311 could be replaced with, or dually function as, a voice receiver for communicating with the message service. Speaker 311 could also be used for listening and speaking into, much like an intercom. In this way, a PIN code could be received which could then be used to retrieve the message from the messaging service. Additionally, keypad 313 could be used to input credit card account information so that the messaging service can collect fees for accessing the message. Further, credit card information could be linked to the person's PIN code or their biometric data, which would allow the messaging service to charge fees when the device 310 is used. Further still, a person could pre-pay the messaging service for accessing the messages.

A royalty system could be incorporated into the system for providing recordings to loved ones. The royalties could be based on the fees collected from accessing the messages. Every time a fee is collected for accessing a message, the person who offered the service to the client, (e.g., a funeral director), could get a percentage of this fee as a royalty. This would provide small incremental payments, but would be paid out over an extended period of time as the messages are accessed. The royalty payments could also be based on the initial setup fee paid by the client. When the client initially sets up their account and leaves messages, they could be charged an initiation fee. The royalty payments could be based on these initial fees, which would provide for a larger payment based on of this one time set up charge.

Other opportunities for offering the messaging service include estate attorneys, who when wills are being made could sell the service. Further, churches and synagogues could offer the service when death counseling is being offered. Also, if the message is related to some special day, it can be offered through greeting card stores. Thus, this royalty system would provide distribution of a portion of the income to:

Estate lawyer

Funeral director

Cemetery/Mausoleum

Church or Synagogue

Card Stores

Charity of Choice

Perpetual care or message storage could be made available for a particular price. This could assure that the message was available for a reasonably long period of time, if not forever.

Perpetual care could also be made available for any equipment located at the gravesite, such as device 10, which would ensure that the equipment was in good working order and available for use.

While the invention has been particularly shown and described with reference to preferred embodiments thereof, it will be understood by those skilled in the art that various changes in form and details may be made therein without departing from the spirit and scope of the invention.

We claim:

1. A method for sending and receiving messages comprising:
receiving a message at a message center, wherein the message is created by a first person, said message having a designed time when it may be disclosed;
storing the message at the message center;
notifying a second person, who is at least one of a possible plurality of persons that the message is intended for, of the existence of the message;
receiving a request at the message center from the second person to have the message disclosed;
determining whether the second person has permission to access the message; and
providing the message to the second person after the designated time upon determining that the second person has permission to access the message.

2. The method of claim 1, wherein the step of providing the message involves making the message available to the second person at the gravesite of the first person.

3. The method of claim 2, wherein the step of making the message available involves accessing the message using a cellular phone, a hand held device having a wireless internet connection, a kiosk at the cemetery, or using a message retrieval device located at the gravesite.

4. The method of claim 1, wherein the step of notifying the second person involves providing notification in a will, in a letter, or on a gravestone of the first person.

5. The method of claim 1, wherein the designated time is the death of the first person and the step of notifying the second person is performed by the message center after the message center learns of the death of the first person.

6. The method of claim 1, wherein the step of creating a message involves creating a plurality of messages, wherein certain messages can be designated to be accessed only by select persons and other certain messages can be designated to be accessed by groups of people.

7. The method of claim 1, wherein the step of receiving a message involves receiving a messages that has a designated time associated with it that is a specific date in the future, wherein the associated messages can only be accessed once the future date has occurred.

8. The method of claim 1, wherein the message is an audio message, video message, or a combination audio and video message.

9. The method of claim 1, wherein the message can be accessed through a telephone system or through the Internet.

10. The method of claim 1, wherein the message is a general message and permission to access the message is granted to anyone.

11. The method of claim 1 further comprising:
providing the second person with a password after determining that the second person has permission to access the message, wherein the password may be used by the second person to access the message at any time of convenience.

12. The method of claim 1, wherein the step of determining whether the second person has permission to access the message involves the message center receiving identifying information from the second person.

13. The method of claim 1, wherein the step of determining whether the second person has permission to access the message involves using biometric information.

14. The method of claim 13, wherein the biometric information is collected using biometric identification means, which can include a fingerprint scanner, retinal scanner, or DNA sampler located at the gravesite of the first person.

15. A method for sending and receiving messages comprising:
receiving a message at a message center from a first person contacting the message center;
recording the message at the message center;
storing the recorded message at the message center;
notifying a second person, who is at least one of a possible plurality of persons that the message is intended for, of the existence of the message after a specified event designated by the first person;
receiving at the message center a contact from the second person;
determining at the message center whether the second person has permission to access the message based on a response to at least one identifying question and verifying that the specified event has occurred; and
allowing the second person to access the message.

16. The method of claim 15 wherein the specified event is the death of the first person and access to the message is allowed at the gravesite of the first person.

17. The method of claim 15 further including the step of providing the second person with a password that can be used to access the message upon determining that the second person has permission to access the message.

18. The method of claim 15, wherein the step of notifying the second person of the existence of the message is accomplished by advertising.

19. A system for providing messages at designated times, comprising:
communications devices for sending and receiving messages;
a database for storing information about a message including the person sending the message, the intended recipient and a specific event before which the message is not to be disclosed;
a storage device for storing a received message created by a first person; and
a processor for determining whether a second person has permission to access the message, for notifying the second person of the existence of the message and for providing access to the message by the second person after their identity has been verified and after the specific event has occurred.

20. The system of claim 19 further including means for receiving biometric information from the second person and for authenticating the identity of the second person as a result thereof.

21. A message center for providing access to messages at a gravesite comprising:
a database of recorded messages and information concerning those to receive the messages and when they are to receive them, said information including biometric information about a second person who is to receive the message;
a communications network for receiving at the message center a message created by a first person, the communications network further receiving at the message center biometric information of the second person that has been scanned the gravesite of the first person;
a processor at the message center which compares the received biometric information with the stored biometric information of a person who has permission to access the message, and transmits the message to an output device located at the gravesite once it has been determined that the second person has permission to access the message.

22. The message center of claim 21, wherein the message is transmitted for reproduction over headphones, a PDA, a computer, or a cell phone located at the gravesite
